(19) United States
(12) Patent Application Publication
(10) Pub. No.: US 2009/0063248 A1
(43) Pub. Date: Mar. 5, 2009

(54) EDUCATION SYSTEM TO IMPROVE ONLINE REPUTATION

(75) Inventors: Jerry T. Chong, San Jose, CA (US); Marc Delingat, Mountain View, CA (US); Brian Burke, San Jose, CA (US); Matthew J. Halprin, Menlo Park, CA (US); Milenko Milanovic, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc., San Jose, CA (US)

(21) Appl. No.: 11/848,727

(22) Filed: Aug. 31, 2007

(51) Int. Cl. G06Q 30/00; G06F 17/30; G06F 17/40

(52) U.S. Cl. 705/10

(57) ABSTRACT

A method and a system for improving online reputation through education are provided. Example embodiments may include analyzing information related to a first entity associated with a transaction to derive present reputation data for the first entity and automatically taking action to educate the first entity in order to improve future reputation data. According to example embodiments, the system may include an analysis module, one or more database, an advice module, an action module and a user interface.

### TECHNICAL FIELD

Example embodiments relate generally to the technical field of data processing, and in one specific example, to an education system for improving online reputation.

### BACKGROUND

The Internet and the World Wide Web (“Web”) have changed the landscape of information delivery and affected numerous aspects of life, including commerce and entertainment. One area that has benefited from this technological development is the ability of individuals to buy and sell products within an Internet marketplace community. Many companies operate auctions or other selling mechanisms on servers connected to users over one or more networks, typically including the Internet. The users buying and/or selling items over these networks loosely comprise a marketplace community within an electronic environment. A distinction between non-electronic selling practices such as traditional garage sales and current electronic selling mechanisms is the component of anonymity inherent in an electronic environment, which is not always conducive to forming a trusting environment in which two or more users wish to form a business relationship.

To overcome some reservations about the anonymity component within the electronic marketplace community and to provide incentives for participating in transactions within electronic marketplaces, Internet marketplaces, such as auction sites run by eBay, Inc. of San Jose, Calif., provide feedback ratings generated from feedback between users regarding transactions. A user's feedback rating may indicate the user's reputation within the electronic community and provides some indication of the trustworthiness and responsiveness of that user. A representation of a user's feedback rating is typically displayed along with a business transaction request by the user. This feedback rating provides the other party to the transaction an indication of the trustworthiness or past participation level of the user.

Feedback ratings may provide a useful mechanism for indicating a level of user's trustworthiness or past participation within an electronic commerce forum. Users desire to increase their feedback ratings because they are one indication of a user's reputation in the electronic community, and users with high feedback ratings may enjoy expanded opportunities to transact business and obtain higher profits or access to more goods and services. To further motivate the earning of a high feedback rating, some marketplace providers give awards or identify the users whose feedback ratings have reached a certain value, or who are among some number of users with the highest feedback ratings.

### BRIEF DESCRIPTION OF THE DRAWINGS

Some embodiments are illustrated by way of example and not limitation in the figures of the accompanying drawings in which:

FIG. 1 is a high level diagram depicting an example embodiment of an education system for improving online reputation;

FIG. 2 is a block diagram illustrating an example embodiment of an education system for improving online reputation, including example system modules;

FIG. 3 is a flow diagram illustrating an example embodiment of a method for improving online reputation through education;

FIG. 4 is a flow diagram depicting an example embodiment of a method for improving online reputation through education and promotion;

FIG. 5 is a diagram illustrating in an example embodiment sets of instances where online reputations of sellers, buyers, or service providers may need improvements;

FIG. 6 is an example list of instances where the online reputation of sellers, buyers, or service providers may need improvements, followed by respective example educational actions recommended;

FIG. 7 is high level block diagram illustrating an example embodiment of a network-based commerce system, having a client-server architecture, using education and promotion to improve online reputation;

FIG. 8 is an example set of marketplace and educational applications used by the network-based commerce system of FIG. 7; and

FIG. 9 is a block diagram illustrating a diagrammatic representation of a machine in the example form of a computer system.

### DETAILED DESCRIPTION

Example methods and systems for improving online reputation through education have been described. In the following description, for purposes of explanation, numerous specific details are set forth in order to provide a thorough understanding of example embodiments. It will be evident, however, to one skilled in the art that the present invention may be practiced without these specific details.

Some embodiments described herein may include capturing detailed information about how a transaction was perceived by the transaction parties. The detailed information may include text and structured data captured in terms of certain feedback ratings. The feedbacks may be analyzed and the result of the analysis may be utilized to improve on the transaction participants' skills and behaviors, such future transactions may be better experiences for the transaction parties. This improvement of skills and behaviors may result in reducing conflicts and thus making transactions smoother and better.

An example method may include analyzing information related to a first entity associated with a transaction to derive present reputation data (e.g., feedback comments and ratings available at the time of the analysis) for the first entity and automatically taking action to educate the first entity in order to improve future reputation data (e.g., feedback comments and ratings after the education actions) for the first entity.

According to example embodiments, the transaction may include an online business transaction (e.g., selling or buying items in a marketplace, providing or receiving online services, and the like). The information may include feedback information received from second entities with which the first entity has transacted. The first entity associated with the transaction may include a seller, a buyer, or a service provider (e.g., a seller or a buyer in a marketplace or an online service provider).

Example embodiments may include determining whether the present reputation data indicates that the first entity has a low performance (e.g., relative to an average performance by all other market participants, or a determined acceptable performance level) in an aspect related to a transaction activity and, based on the determination, taking action to educate the first entity including automatically providing the first entity with an educational object.

The educational object may include a real-time message (e.g., an email, an instant message, a voice mail, etc.) or a tutorial material. The tutorial material, for example, may include any material that might assist a person to overcome shortcomings and low performances associated with various aspects of business transactions (e.g., shipping and handling of sold items, quality of a written description of listings or advertisements, customer service, communication with customers, or making timely payments). The education object, for example, may be provided at the time that the first entity logs into an account associated with the first entity, the first entity lists an item in the market place, or the first entity logs out of the account.

According to example embodiments, a method may include determining whether the present reputation data indicates that the first entity has a high performance (e.g., relative to an average performance by all other market participants, or a determined acceptable performance level) in an aspect related to a transaction activity (e.g., shipping and handling, communication, etc.) and, based on the determination, automatically taking further action to promote the first entity.

The promotion of the first entity may, for example, include advertising the first entity as the best seller/buyer of a week, a month or a year. The promotion of the first entity may also include offering free or discounted services to the first entity.

In one example embodiment, a method may include enhancing granularity of ratings to assist a recipient of the ratings in perceiving an issue related to the ratings. The granularity enhancement may include asking transaction participants to leave more specific feedbacks. For example, the transaction participants may be asked to specify particular aspects of the shipping and handling with which the participant was not satisfied (e.g., be specific to whether it was the cost, timeliness, quality of packaging, or some other aspect).

According to example embodiments, a method may include providing suggestions to the first entity, the suggestion being to target buyers by email messages and advertisements emphasizing reputations associated with the seller (e.g., high positive feedback ratings, best seller of the month, etc.). A method may also include providing suggestions to sellers/service providers to target respective buyers/clients with coupons and advertisements, based on a transaction and feedbacks received from the buyer on that transaction, or the value of the transaction. For example a seller may send coupons to buyers who have certain qualifications e.g., frequent buyers, buyers who might have left positive feedbacks, buyers of high value items, etc. The method may include directing a real-time message to the first entity. The real-time message may include a reminder that the first entity has at least one unread message in a mailbox.

### Example System Architecture

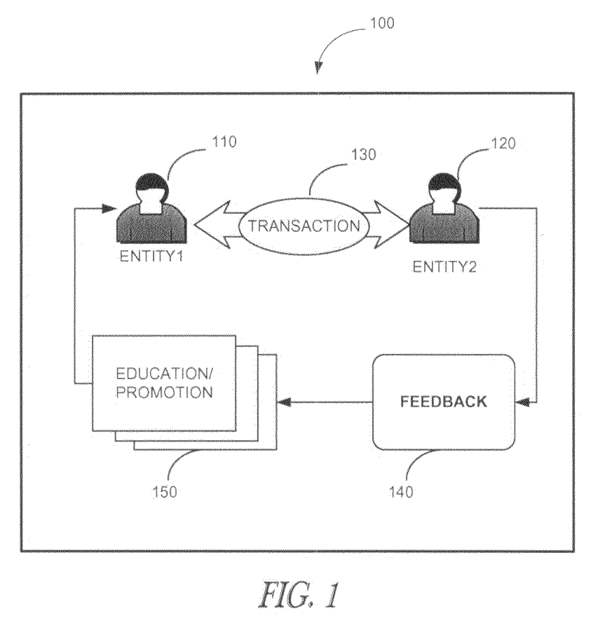

FIG. 1 is a high level diagram depicting an example embodiment of an education system 100 for improving online reputation. The example system 100 illustrates that the first entity 110 may participate in a transaction 130 with a second entity 120. In an example embodiment, the transaction 130 may include an online business transaction (e.g., selling or buying items in a marketplace, providing or receiving online services and the like). In example system 100 feedback 140 may be received from second entity 120 concerning the transaction that the second entity 120 entered into with the first entity 110. The feedback 140 may be a positive or a negative feedback, and provide a rating related to the first entity 110 in one or more aspects of the transaction 130. For example, the feedback 140 may be related to the shipping and handling, communication, quality of a listing, timeliness, quality of a service provided etc.

In an example embodiment, the education system 100 may analyze the feedback 140 and, based on the result of the analysis, apply education/promotion rules 150 to the first entity 110. Examples of education/promotion rules 150 may include providing the first entity 110 with an educational object, in response to the system 100 determining that the feedback 140 indicated a low performance on an aspect of the transaction 130.

In an example embodiment, the educational object may include, inter alia, a real-time message (e.g., an email, an instant message, a voicemail, etc.) or a tutorial material. The tutorial material, for example, may include any material that might assist a person to overcome shortcomings and low performances associated with various aspects of the transaction 130 (e.g., shipping and handling of sold items, quality of a written description of listing or advertisements, customer service, communication with customers, or making timely payments). The education object for example may be provided at the time that the first entity 110 logs into an account associated with the first entity 110, at the time that the first entity 110 lists an item in the marketplace or when the first entity 110 logs out of the account.

In example embodiments when the feedback 140 indicates that the first entity 110 has a high performance in an aspect related to the transaction 130 (e.g., shipping and handling, communication, etc.), the system 100 may automatically take an action to promote the first entity 110. The promotion of the first entity 110 may for example include advertising the first entity 110 as the best seller/buyer of a week (or month, or year). The promotion of the first entity 110 may also include offering, by the system 100, free or discounted services to the first entity 110.

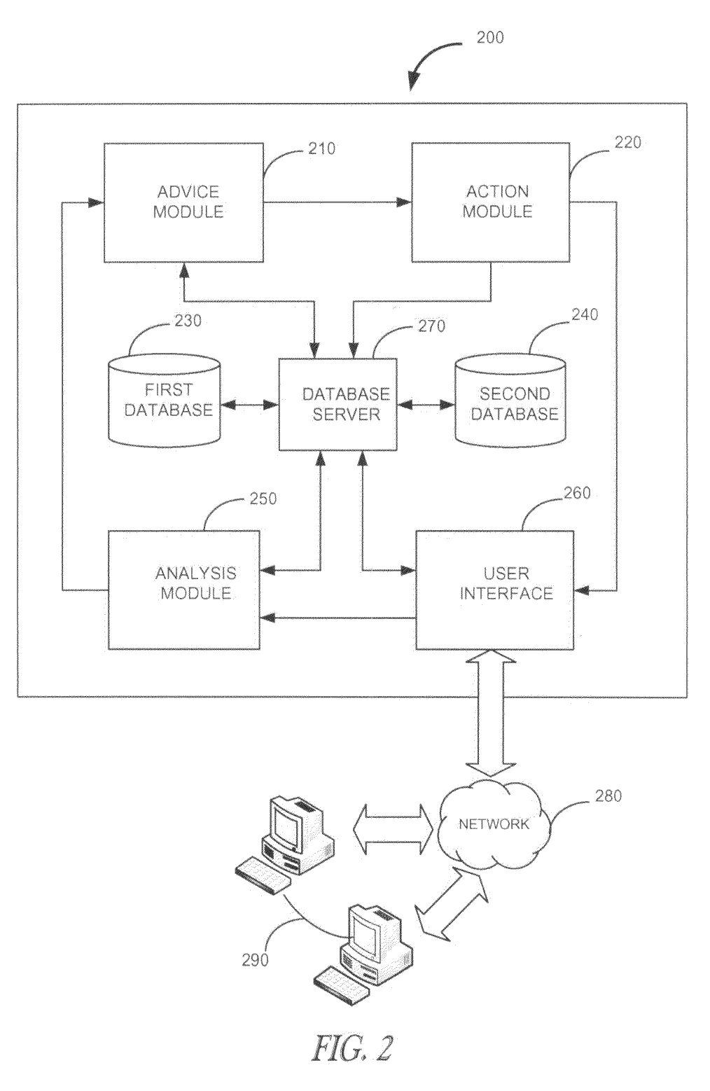

FIG. 2 is a block diagram illustrating an example embodiment of an education system 200 for improving online reputation, including example system modules. According to an example embodiment, the education system 200 may include an analysis module 250, an advice module 210, an action module 220, a first database 230, a second database 240, a database server 270 and a user interface 260. The first database 230 may, inter alia, maintain the information related to the first entity 110 and corresponding to the transaction 130. The information may include the feedback 140 received from the second entity 120.

The second database 240 may store data including advertisement, messages and tutorial materials (e.g., computer files, CDs, DVDs, paper publications, documents, etc.). The first entity 110 and the second entity 120 may use user computers 290 to communicate via network 280 with the system 200. The system 200 may use the user interface 260 to receive the feedback 140 from the user computers 290, e.g., via the network 280, and store the received feedback 140 through the database server 270 to the first database 230.

The analysis module 250 may retrieve information including the feedback 140 stored in the first database 230, using the database server 270. The analysis module 250 may analyze the information received from the first database 230 and determine that the first entity 110 has a negative feedback, meaning a low performance, with respect to one aspect of the transaction 130. In alternative examples, the analysis module 250 may determine that the first entity 110 had positive feedbacks or high rating in certain aspects of the transaction 130.

According to example embodiments, the advice module 210, based on the analysis performed by the analysis module 250 of the feedback 140, may recommend that one or more actions be taken to educate the first entity 110, in order to improve future reputation data (e.g., the feedback 140 corresponding to the transaction 130). Based on the positive results associated with the first entity 110 received from the analysis module 250, the advice module 210 may recommend that the first entity 110 be promoted.

In response to the recommendation received from the advice module 210, the action module 220 may cause the database server 270 to retrieve educational objects from the second database 240 and transfer the educational objects to the user interface 260 to be communicated to the first entity 110 via the network 280 (e.g., the Internet) and the user computers 290.

According to example embodiments, the educational objects may include a real-time message (e.g., an email, an instant message, a voice mail, etc.) or a tutorial material. The tutorial material, for example, may include any material that might teach or otherwise help a person to alleviate shortcomings and low performances associated with various aspects of business transactions (e.g., shipping and handlings of sold items, quality of a written description of listings or advertisements, customer service, communication with customers, or making timely payments). The educational objects, for example, may be provided at the time that the first entity 110 logs into an account associated with the first entity 110, the first entity 110 lists an item in a market place, or the first entity 110 logs out of the account.

In some embodiments, the action module 220, based on the recommendations from the advice module 210, may cause the database server 270 to retrieve promotional objects from the second database 240 and to transfer the promotional objects to the user interface 260, for transmission of the promotional objects through the network 280 and the user computers 290 to the first entity 110.

According to some example embodiments, the promotional objects may include advertisements presenting the first entity as the best seller/buyer of a week or a month or a year. The promotional objects may also include list of free or discounted services offered to the first entity.

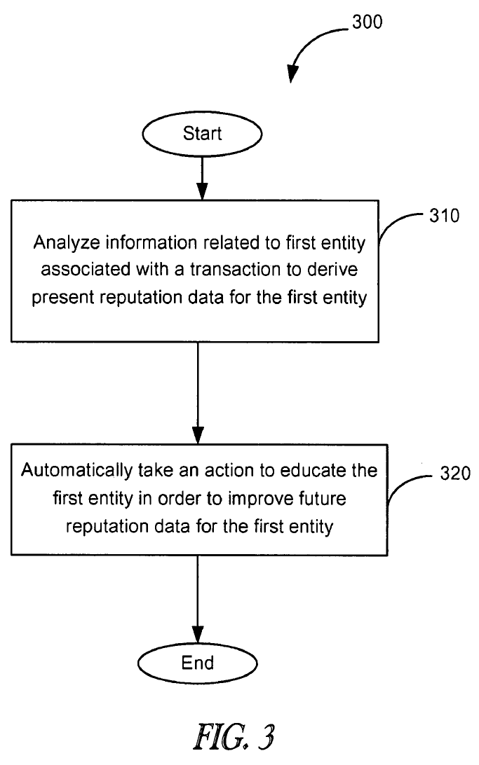

FIG. 3 is a flow diagram illustrating an example embodiment of a method 300 for improving online reputation through education. The method 300 starts at operation 310 where the analysis module 250 analyzes the information related to the first entity 110 associated with the transaction 130 to derive present reputation data, including feedback 140 for the first entity 110. The feedback may be positive or negative feedback providing a rating related to the first entity 110 in one or more aspects of the transaction 130. For example, the feedback may be related to the shipping and handling, communication, quality of a listing, timeliness, quality of a service provided etc.

At operation 320, the action module 220 may automatically take an action to educate the first entity 110 in order to improve future reputation data, including the feedback 140, for the first entity 110, including automatically providing the first entity with an educational object. The educational object may include a real-time message (e.g., an email, an instant message, a voice mail, etc.) or a tutorial material. The tutorial material, for example, may include any material that might help a person to overcome shortcomings and low performances associated with various aspects of business transactions (e.g., shipping and handlings of sold items, quality of a written description of listings or advertisements, customer service, communication with customers, or making timely payments).

The education object, for example, may be provided at the time that the first entity logs into an account associated with the first entity, the first entity lists an item in the market place, or the first entity logs out of the account.

In some example embodiments, the educational object may include an advice to the first entity 110 to provide a second entity 120 (e.g., a buyer), who left a negative feedback, with discounts or coupons. This may persuade the second entity 120 to continue transacting with the first entity 110 and hopefully experience a happier future transaction. The educational object may include a recommendation to the first entity 110 to block the second entity 120 who left a negative feedback.

According to some example embodiments, the educational object may include an advice to the first entity 110 to target a second entity 120, who left a positive feedback, with certain goods and services. The educational object may include a recommendation to the first entity 110 to use advertisements to target a second entity 120 who left a positive feedback.

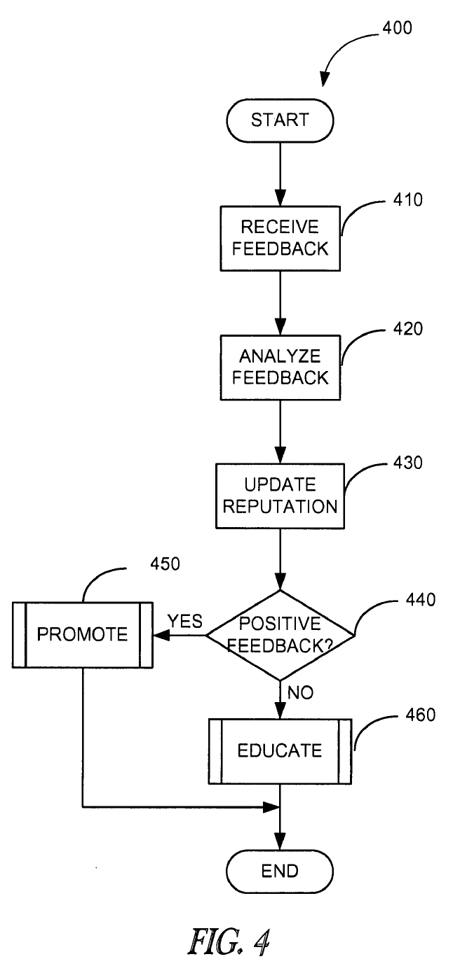

FIG. 4 is a flow diagram depicting an example embodiment of a method 400 for improving online reputation through education and promotion. The method 400 starts at operation 410, where the user interface 260 receives feedback 140 from the first entity 110 via the user computers 290 and the network 280.

According to an example embodiment, at operation 420 the analysis module 250 may analyze the information, including the feedback 140 received from the second entity 120, and at operation 430, update (e.g., via the database sever 270) the present reputation data, including feedback 140, stored in the first database 230 via the database server 270. At control operation 440, the analysis module 250 may determine whether the present reputation data (e.g., the feedback 140) is positive. If the feedback turns out to be positive, at operation 450 the advice module 210 may recommend that the first entity 110 be promoted.

Based on the recommendation by the advice module 210, the action modules 220 may act to promote the first entity 110. In some embodiments, if the feedback 140 is negative, at operation 460 the advice module 210 may recommend that an action be taken to educate the first entity 110 in order to improve future reputation data (e.g., feedback 140).

The action module 220 may act upon the recommendation by the advice module 210, including automatically providing the first entity 110 with an educational object. The educational object may for example include one or more real-time messages or tutorial materials (e.g., computer files, CDs, DVDs, paper publications, documents, etc.).

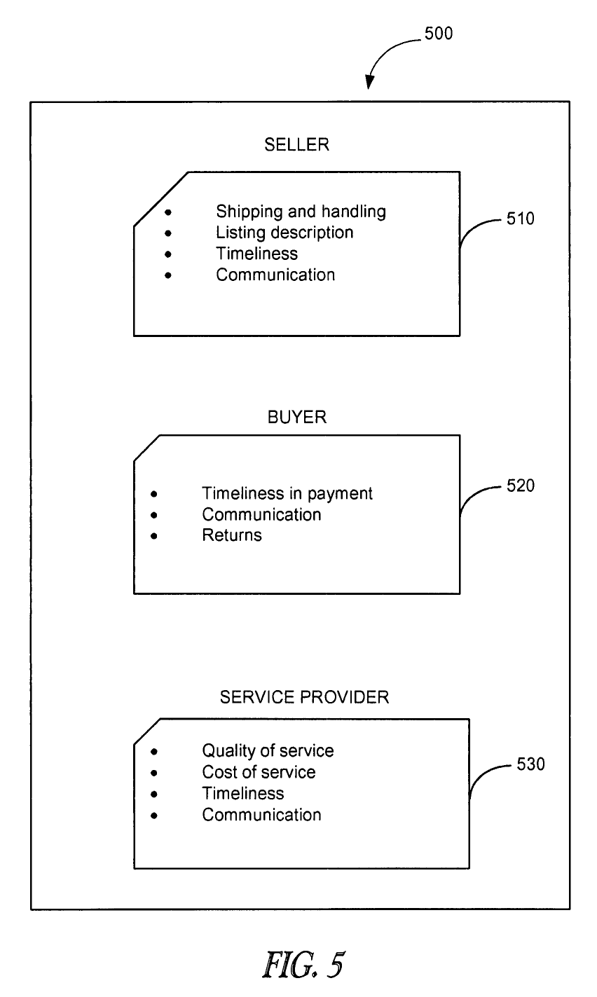

FIG. 5 is a diagram illustrating in example embodiments a set 500 of instances where online reputation of sellers, buyers or service providers may need improvement. According to an example embodiment, when the first entity 110 is a seller, the improvements recommended by the advice module 210 may be related to certain aspects of the transaction 130, including the ones presented in list 510. The list 510 includes shipping and handling (e.g., the first entity 110 had negative feedback on some shipping and handling aspects, such as shipment timing or quality of packaging), listing description (e.g., a vague description of a listed item or a description lacking some key features of the listed items, etc.), timeliness (e.g., in answering questions raised by the second entity 120) and communication issues.

The list 520 includes aspects of the transaction 130 where the first entity 110 is a buyer and the second entity 120 is a seller and the seller has left feedback on certain aspects of the transaction 130, including timeliness in payment of the transaction amount by the buyer (e.g., the first entity 110), communication issue, and returns of items by the buyer.

In an example embodiment, the first entity 110 may be a service provider of some business service (e.g., consulting, advertising, marketing, counseling, etc.) In this case, the second entity 120, as a client, may leave feedback for the first entity 110 (e.g., the service provider), on some aspects of the transaction 130 presented in list 530, including quality of service, cost of service, timeliness, and communication.

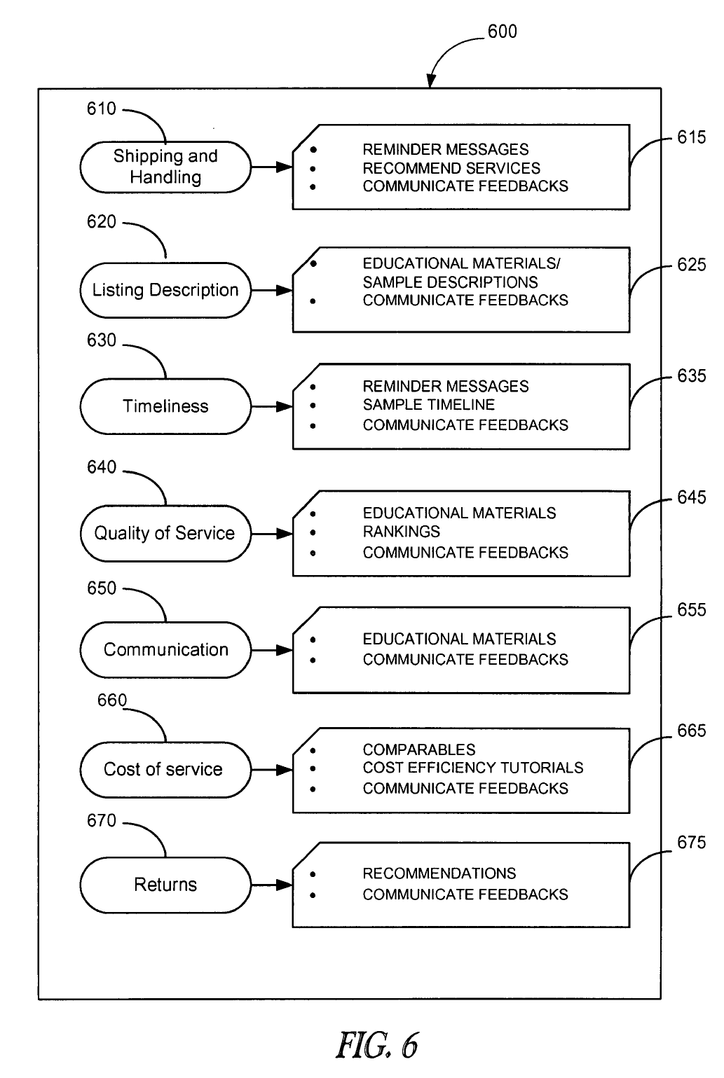

FIG. 6 is an example list 600 of instances where online reputation of sellers, buyers or service providers may need improvements, including respective example educational actions recommended. The list 600 depicts various problems, related to the transaction 130 addressed in feedbacks 140, followed by a list of actions that might be taken by the action module 220 to alleviate each problem.

In an example embodiment, when the feedback 140 is related to shipping and handling (instance 610), the listed actions 615 may include sending reminder messages, recommending shipping or fulfillment services, or communicating feedbacks related to shipping and handling. In one example embodiment, all of the listed actions may be performed by the action module 220. The reminder messages may include email, voicemail, instant message, etc. The messages may, for example, remind the first entity 110 about shipment of an item sold prior to the date the shipment is due. The action module 220 may also provide the first entity 110 with information regarding a shipping vendor that the first entity 110 may use to ship the item, or send to the first entity coupons for shipping services. In an example embodiment, the action module 220 may forward the feedbacks 140 received from the second entity 120 to the first entity 110.

In an example embodiment, where the feedback 140 suggests that the first entity 110 has a negative rating with respect to listing description (instance 620), the advice module 210 may recommend the actions presented in list 625 to be taken to mitigate the situation. The listed actions in list 625 may include providing the first entity 110 with educational materials, sample listing descriptions, or communicating feedbacks. In one example embodiment, all of the listed actions may be performed by the action module 220. The educational materials may provide tutorials on how to prepare listings. The action module 220 may also provide the first entity 110 with sample listings. In one example embodiment, the action module 220 may forward the feedbacks 140 received from the second entity 120 to the first entity 110.

In an example embodiment where the feedback 140 indicates that the timeliness is an issue (instance 630) the action module 220 may act upon the recommendations provided in list 635, including sending appropriate reminder messages and/or sample timelines for taking recommended actions at various stages of a transaction and communicating feedbacks to the first entity 110.

At instance 640, where the first entity 110 has received a feedback related to quality of service, the recommended actions in list 645 may include sending educational materials, rankings and communicating feedbacks to the first entity. In one example embodiment, all of the listed actions may be performed by the action module 220.

In example embodiments, when the first entity 110 has received negative feedbacks with respect to communication (650), the action module 220 may act upon the recommendations of the advice module 210 noted in list 655, including providing the first entity 110 with educational materials and/or communicating feedbacks received from the second entity 120 to the first entity 110.

In an example embodiment, where a high cost of service is reflected in the feedback 140 (instance 660), the action module 220 may act upon the recommendations of advice module 210 offered in list 665, including providing the first entity 110 with comparable prices and/or cost efficiency tutorials or communicating cost related feedbacks to the first entity 110. The comparable prices may relate to comparable services provided by other providers including the first entity's competitors. The cost efficiency tutorials may include educational materials (e.g., computer files, CDs, DVDs, paper publications, documents, etc.)

In one example embodiment, where the first entity 110 is a buyer, the feedback 140 related to the first entity may correspond to returns made by the first entity 110 (instance 670). In this case the analysis module 250 may determine that the first entity 110 has negative feedback ratings on returns. In response, the action module 220 may send multiple recommendation with respect to returning items and/or communicate the relevant feedbacks received from the second entity 120 to the first entity 110.

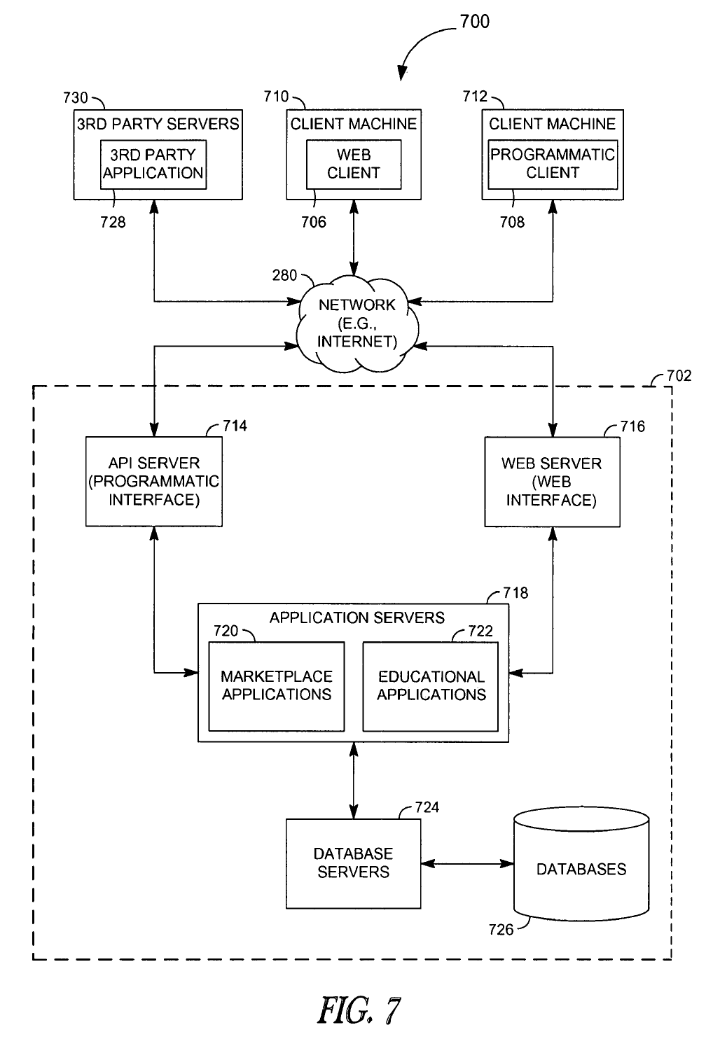

FIG. 7 is a high-level block diagram illustrating an example embodiment of a network-based commerce system 700, having a client-server architecture using education and promotion to improve online reputation. A commerce platform, in the example form of a network-based marketplace 702, provides server-side functionality, via a network 280 (e.g., the Internet) to one or more clients. FIG. 7 illustrates, for example, a web client 706 (e.g., a browser, such as the Internet Explorer browser developed by Microsoft Corporation of Redmond, Wash.), and a programmatic client 708 executing on respective client machines 710 and 712.

Turning specifically to the network-based marketplace 702, an Application Program Interface (API) server 714 and a web server 716 are coupled to, and provide programmatic and web interfaces respectively to, one or more application servers 718. The application servers 718 host one or more marketplace applications 720 and educational applications 722. The application servers 718 are, in turn, shown to be coupled to one or more database servers 724 that facilitate access to one or more databases 726.

The marketplace applications 720 provide a number of marketplace functions and services to users that access the marketplace 702. The educational applications 722 provide educational services to improve the user's online reputation.

Further, while the system 700 shown in FIG. 7 employs a client-server architecture, the present application is of course not limited to such an architecture, and could equally well find application in a distributed, or peer-to-peer, architecture system. The various marketplace and educational applications 720 and 722 may also be implemented as standalone software programs, which do not necessarily have networking capabilities.

The web client 706, it will be appreciated, may access the various marketplace and educational applications 720 and 722 via the web interface supported by the web server 716. Similarly, the programmatic client 708 accesses the various services and functions provided by the marketplace and educational applications 720 and 722 via the programmatic interface provided by the API server 714. The programmatic client 708 may, for example, be a seller application (e.g., the TurboLister application developed by eBay Inc., of San Jose, Calif.) to enable sellers to author and manage listings on the marketplace 702 in an off-line manner, and to perform batch-mode communications between the programmatic client 708 and the network-based marketplace 702.

FIG. 7 also illustrates a third party application 728, executing on a third party server machine 730, as having programmatic access to the network-based marketplace 702 via the programmatic interface provided by the API server 714. For example, the third party application 728 may, utilizing information retrieved from the network-based marketplace 702, support one or more features or functions on a website hosted by the third party. The third party website may, for example, provide one or more promotional, marketplace or payment functions that are supported by the relevant applications of the network-based marketplace 702.

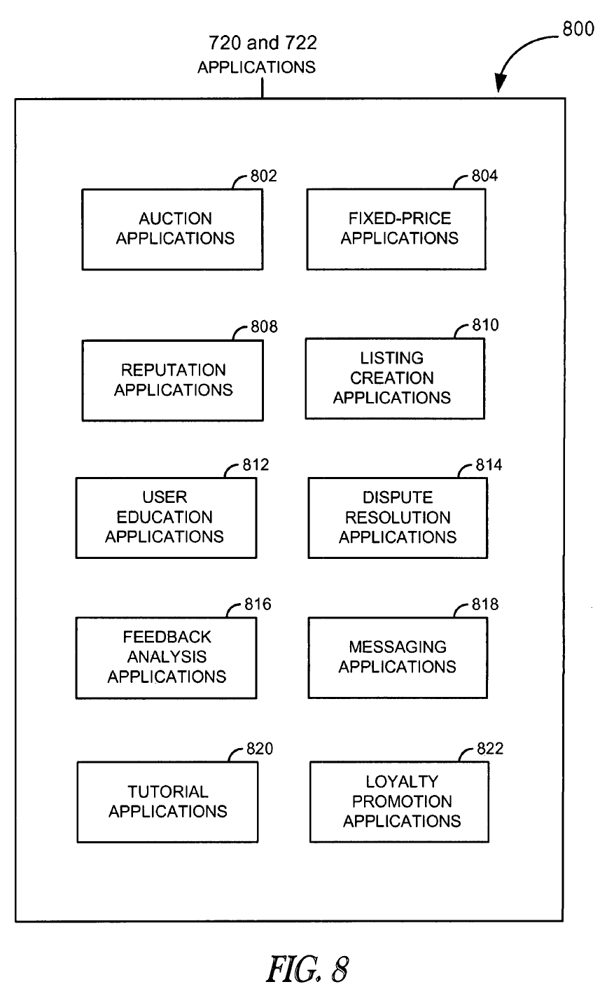

FIG. 8 is a diagram illustrating multiple example marketplace and educational applications 800 that, in one example embodiment, are provided as part of the network-based marketplace 702. The marketplace 702 may provide a number of listing and price-setting mechanisms whereby a seller may list goods or services for sale, a buyer can express interest in or indicate a desire to purchase such goods or services, and a price can be set for a transaction pertaining to the goods or services.

The marketplace applications 720 are shown to include one or more auction applications 802 which support auction-format listing and price setting mechanisms (e.g., English, Dutch, Vickrey, Chinese, Double, Reverse auctions etc.). The various auction applications 802 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 804 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Reputation applications 808 may allow parties that transact utilizing the network-based marketplace 702 to establish, build and maintain reputations related to a first entity 110, which may be made available and published to potential trading partners. Consider that where, for example, the network-based marketplace 702 supports person-to-person trading, users may have no history or other reference information whereby the trustworthiness and credibility of potential trading partners may be assessed. The reputation applications 808 may allow a user, for example through feedback provided by other transaction partners, to establish a reputation within the network-based marketplace 702 over time. Other potential trading partners may then reference such a reputation for the purposes of assessing credibility and trustworthiness.

Listing creation applications 810 may allow sellers to conveniently author listings pertaining to goods or services that they wish to sell via the marketplace 702.

As part of the educational applications 722, user education applications 812 may provide guidelines and support materials (e.g., computer files, CDs, DVDs, paper publications, documents, etc.) for educating users of the network-based marketplace 702 to improve their online reputations established through the use of reputation applications 808.

Dispute resolution applications 814 may provide mechanisms whereby disputes arising between transacting parties may be resolved. For example, the dispute resolution applications 814 may provide guided procedures whereby the parties are guided through a number of steps in an attempt to settle a dispute. In the event that the dispute cannot be settled via the guided procedures, the dispute may be escalated to a third party mediator or arbitrator.

Feedback analysis applications 816 may allow the network-based marketplace 702 to analyze feedbacks received by the reputation applications 808 and make assessments with respect to performances of the trading parties. The feedback analysis applications 816 may make suggestions to the user education applications 812 to take proper educational steps in order to improve the trading parties' online reputation.

Messaging applications 818 are responsible for the generation and delivery of messages to users of the network-based marketplace 702. Such messages may, for example, advise users regarding the status of listings at the network-based marketplace 702 (e.g., providing “outbid” notices to bidders during an auction process or providing promotional and merchandising information to users) or remind them of certain actions that they may need to take in order to improve their online reputations.

Tutorial applications 820 may provide educational support materials (e.g., computer files, CDs, DVDs, paper publications, documents, etc.) for the user education applications 812 to assist users of the network-based marketplace 702 to improve their online reputation.

The network-based marketplace 702 itself, or one or more parties that transact via the marketplace 702, may operate loyalty programs that are supported by one or more loyalty/promotions applications 822. For example, a buyer may earn loyalty or promotions points for each transaction established and/or concluded with a particular seller and be offered a reward for which accumulated loyalty points can be redeemed.

### Machine Architecture

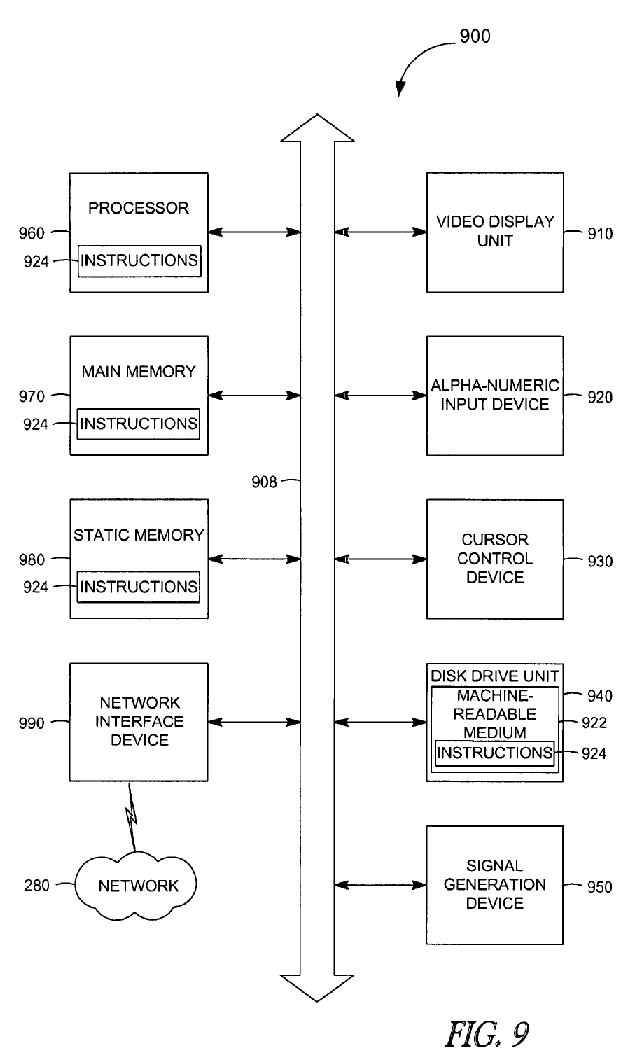

FIG. 9 is a block diagram, illustrating a diagrammatic representation of machine 900 in the example form of a computer system within which a set of instructions for causing the machine to perform any one or more of the methodologies discussed herein may be executed. In alternative embodiments, the machine 900 may operate as a standalone device or may be connected (e.g., networked) to other machines. In a networked deployment, the machine 900 may operate in the capacity of a server or a client machine in a server-client network environment, or as a peer machine in a peer-to-peer (or distributed) network environment. The machine 900 may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 may include a processor 960 (e.g., a central processing unit (CPU), a graphics processing unit (GPU) or both), a main memory 970 and a static memory 980, all of which communicate with each other via a bus 908. The computer system 900 may further include a video display unit 910 (e.g., liquid crystal displays (LCD) or cathode ray tube (CRT)). The computer system 900 also may include an alphanumeric input device 920 (e.g., a keyboard), a cursor control device 930 (e.g., a mouse), a disk drive unit 940, a signal generation device 950 (e.g., a speaker) and a network interface device 990.

The disk drive unit 940 may include a machine-readable medium 922 on which is stored one or more sets of instructions (e.g., software 924) embodying any one or more of the methodologies or functions described herein. The software 924 may also reside, completely or at least partially, within the main memory 970 and/or within the processor 960 during execution thereof by the computer system 900, the main memory 970 and the processor 960 also constituting machine-readable media.

The software 924 may further be transmitted or received over a network 280 via the network interface device 990.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

Thus, a method and a system for improving online reputation through education have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
analyzing information related to a first entity associated with a transaction to derive present reputation data for the first entity; and
automatically taking an action, based on the present reputation data, to educate the first entity in order to improve future reputation data for the first entity.

2. The method of claim 1, wherein the transaction is an online business transaction.

3. The method of claim 1, wherein the information includes feedback information received from a second entity with which the first entity has transacted.

4. The method of claim 1, wherein the first entity associated with the transaction includes at least one of a seller, a buyer, or a service provider.

5. The method of claim 1, wherein the transaction is performed in a marketplace environment.

6. The method of claim 1, including determining whether the present reputation data indicates that the first entity has a low performance in an aspect related to a transaction activity.

7. The method of claim 6, comprising, based on the determination, taking action to educate the first entity including automatically providing the entity with an educational object.

8. The method of claim 7, wherein the educational object includes at least one of a real-time message, tutorial material, or combinations thereof.

9. The method of claim 1, including determining whether the present reputation data indicates that the first entity has a high performance in an aspect related to a transaction activity.

10. The method of claim 9, including, based on the determination, automatically taking further action to promote the first entity.

11. The method of claim 1, comprising enhancing a granularity of ratings to assist a recipient of the ratings in perceiving an issue related to the ratings.

12. The method of claim 1, wherein taking the action to educate the first entity includes providing a suggestion to the first entity, the suggestion being to target a buyer by email messages and advertisements emphasizing a good reputation associated with the first entity.

13. The method of claim 1, wherein taking the action to educate the first entity includes providing a suggestion to the first entity, the suggestion being to target a buyer with coupons and advertisements based on a transaction and feedbacks received from the buyer or a value of the transaction.

14. The method of claim 7, wherein providing the first entity with the educational object occurs in conjunction with at least one of:
the first entity logging into an account,
the first entity listing an item, or
the first entity logging out of an account.

15. The method of claim 6, wherein the aspect related to the transaction includes at least one of:
shipping and handling of sold items,
a quality of a written description of a listing,
a quality of an advertisement,
a customer service,
communication with a customer, or
timeliness of payments.

16. The method of claim 8, wherein the real-time message includes a reminder that the first entity has at least one unread message in a mailbox.

17. A system comprising:
a first database to maintain information related to a first entity associated with a transaction;
an analysis module to analyze the information related to the first entity to derive present reputation data for the first entity;
an advice module to recommend an action to be taken to educate the first entity in order to improve future reputation data, based on an analysis result received from the analysis module; and
an action module to automatically act upon a recommendation received from the advice module.

18. The system of claim 17, wherein the database is to maintain the information related to the first entity associated with the transaction, the information including a feedback received from second entities associated with the transaction and a reputation.

19. The system of claim 17, wherein the first entity includes one of a list, the list consisting of a seller, a buyer, or a service provider.

20. The system of claim 17, wherein the analysis module is to determine whether the present reputation data indicates that the first entity has a low performance in an aspect related to a transaction activity.

21. The system of claim 20, wherein, based on the determination, the advice module is to recommend the action including automatically providing the first entity with an educational object, the educational object including at least one of a real-time message or a tutorial material.

22. The system of claim 17, wherein the advice module is to recommend enhancing a granularity of ratings to assist a recipient of the ratings in perceiving an issue related to the ratings.

23. The system of claim 17, wherein the advice module is to recommend providing a suggestion to the first entity, the suggestion being to target a buyer by email messages and advertisements emphasizing a good reputation associated with the first entity.

24. The system of claim 17, wherein the advice module is to recommend providing a suggestion to the first entity, the suggestion being to target a buyer with coupons and advertisements based on a transaction and a feedback received from the buyer or the value of the transaction.

25. The system of claim 17, wherein the advice module is to recommend directing a real-time message to the first entity, the message including a reminder that the first entity has at least one unread message in a mailbox.

26. The system of claim 20, wherein the aspect related to the transaction activity includes at least one of:
shipping and handling of sold items,
a quality of a written description of a listing,
a quality of an advertisement,
a customer service,
communication with a customer, or
timeliness of payments.

27. The system of claim 17, further comprising a second database to store electronic materials including advertisements, messages, and tutorial materials.

28. The system of claim 17, further comprising a user interface to communicate with the first entity associated with the transaction.

29. A system comprising:
means for analyzing information related to a first entity associated with a transaction to derive present reputation data for the first entity; and
means for automatically taking an action to educate the first entity in order to improve the future reputation data for the first entity.

30. A machine-readable medium comprising instructions, which when implemented by one or more processors perform the following operations:
analyzing information related to a first entity associated with a transaction to derive present reputation data for the first entity; and
automatically taking an action to educate the first entity in order to improve future reputation data for the first entity.
